(19) United States
(12) Patent Application Publication
(10) Pub. No.: US 2014/0313654 A1
(43) Pub. Date: Oct. 23, 2014

(54) Information Input Device

(71) Applicant: BROTHER KOGYO KABUSHIKI KAISHA, Nagoya-shi (JP)

(72) Inventors: Atsushi Kasugai, Nagoya-shi (JP); Akira Sago, Seto-shi (JP); Yasuhiro Shibata, Okazaki-shi (JP); Takehiko Inaba, Chita-gun (JP); Kazuya Kiuchi, Nagoya-shi (JP)

(73) Assignee: BROTHER KOGYO KABUSHIKI KAISHA, Nagoya-shi (JP)

(21) Appl. No.: 14/227,464

(22) Filed: Mar. 27, 2014

(30) Foreign Application Priority Data
Apr. 18, 2013 (JP) 2013-087894

(51) Int. Cl. G06F 3/041

(52) U.S. Cl. CPC G06F 3/041
USPC 361/679.4

(57) ABSTRACT

An information input device includes a digitizer circuit board and a box-shaped housing. The digitizer circuit board is configured to detect a position of an object of detection that is one of close to and in contact with the digitizer circuit board. The box-shaped housing is configured to contain the digitizer circuit board. The housing is constructed by combining at least two members and including a pair of plate walls and a side wall. The at least two members includes a first member that includes a first folded edge portion. The first folded edge portion accommodates an edge of the digitizer circuit board that is contained inside the housing.

### CROSS-REFERENCE TO RELATED APPLICATION

This application claims priority to Japanese Patent Application No. 2013-87894, filed Apr. 18, 2013. The disclosure of the foregoing application is incorporated herein by reference in its entirety.

### BACKGROUND

The present disclosure relates to an information input device that is configured to acquire information that is input on a recording medium that has the shape of a booklet in which a plurality of sheets of paper are bound.

A technology is known that takes information that is recorded on a paper medium that has the shape of a booklet in which a plurality of sheets of paper are bound, converts the information into electronic form, then stores and manages the information. For example, in a known information management system, a person places a notebook on a pad of a digitizer and records handwritten content in the notebook using a special-purpose pen. The handwritten content is read in the form of image data by the digitizer and is stored in the memory of a PC.

A digitizer circuit board is contained within a housing of the digitizer. Static electricity enters the housing either through a portion where members from which the housing is configured are joined, or through a hole that is provided in the housing. When the digitizer reads the track of special-purpose pen as image data, cases occur in which the digitizer circuit board is affected by the static electricity that has entered the housing. One effective measure against static electricity is to position a member that has high electrical conductivity close to a portion where the static electricity passes, the member being grounded to a reference potential, such that the static electricity is channeled off. Another effective measure against static electricity is to provide sufficient distance between the digitizer circuit board and the portion where the static electricity passes to maintain electrical insulation.

### SUMMARY

In a case where the highly conductive member that is positioned close to the portion where the static electricity passes is a located at a long distance from the reference potential, there is a possibility that the highly conductive member cannot be grounded to the reference potential. In a case where sufficient distance is ensured between the digitizer circuit board and the portion where the static electricity passes to maintain electrical insulation, there is a possibility that the size of the housing will be increased.

Various embodiments of the broad principles derived herein provide an information input device that is configured to implement in a compact housing, while still inhibiting the effect of static electricity on the digitizer circuit board that is contained in the housing.

Various embodiments of the broad principles derived herein provide an information input device. The information input device includes a digitizer circuit board and a box-shaped housing. The digitizer circuit board is configured to detect a position of an object of detection that is one of close to and in contact with the digitizer circuit board. The box-shaped housing is configured to contain the digitizer circuit board. The housing is constructed by combining at least two members and including a pair of plate walls and a side wall. The pair of plate walls are respectively positioned opposite two faces of the digitizer circuit board that is contained inside the housing. The side wall is connected to edges of the pair of plate walls. The at least two members include a first member. The first member has a first main wall as a main component of the first member and includes a first folded edge portion. The first main wall is at least a portion of a first plate wall that is one of the pair of plate walls. The first folded edge portion is a portion where the first main wall, the side wall, and a first opposing wall are connected into a single unit in folded form at at least one edge of the first main wall. The first opposing wall is a wall that is positioned opposite the first main wall such that the digitizer circuit board that is contained inside the housing is sandwiched between the first opposing wall and the first main wall. The first folded edge portion accommodates an edge of the digitizer circuit board that is contained inside the housing.

### BRIEF DESCRIPTION OF THE DRAWINGS

Embodiments of the present disclosure will be described below in detail with reference to the accompanying drawings in which:

FIG. 1 is an overall view of an information input device;

FIG. 2 is an oblique view of the information input device in a state in which a notebook has been placed on it;

FIG. 3 is a front view of the information input device on which the notebook has been placed;

FIG. 4 is an oblique view of a detection device;

FIG. 5 is an exploded oblique view of the detection device;

FIG. 6 is another exploded oblique view of the detection device;

FIG. 7 is a section view as seen from the direction that is indicated by arrows I-I in FIGS. 5 and 6;

FIG. 8 is a section view as seen from the direction that is indicated by arrows II-II in FIGS. 5 and 6; and

FIG. 9 is a section view as seen from the direction that is indicated by arrows III-III in FIGS. 5 and 6.

### DETAILED DESCRIPTION

An embodiment that implements the present disclosure will be explained with reference to the drawings. Note that the referenced drawings simply explanatory examples that are used for explaining technological features that the present disclosure can utilize, and they do not serve to limit the present disclosure to the device configurations and the like that are shown in the drawings.

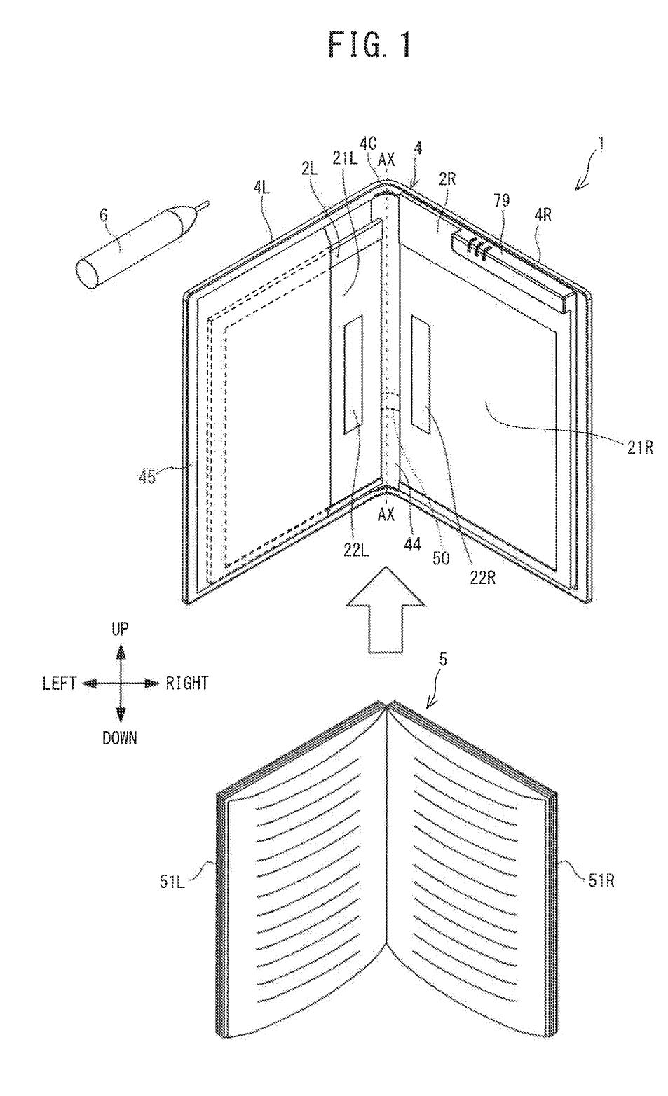

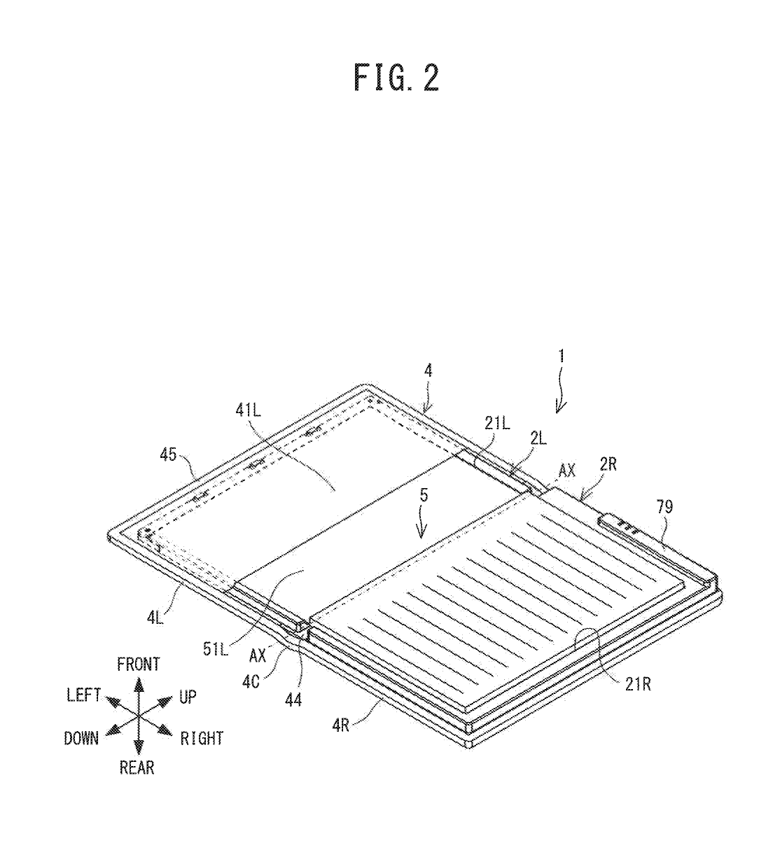

An information input device 1 according to the present embodiment will be explained. In the explanation that follows, the top side, the bottom side, the upper left side, the lower right side, the upper right side, and the lower left side in FIG. 2 respectively define the front side, the rear side, the left side, the right side, the top side, and the bottom side of the information input device 1. For the sake of convenience, the respective sides of an outer cover 4 and detection devices 2L, 2R, which make up the information input device 1, as well as the respective sides of a notebook 5 that is placed on the information input device 1, are defined in the same manner as the sides of the information input device 1. The information input device 1 that is shown in FIG. 1 is in a state in which it is partially open. The information input device 1 that is shown in FIG. 2 is in a state in which it is fully open.

The information input device 1 that is shown in FIG. 1 is a tablet type handwriting input device that a user can carry. The information input device 1 is provided with the outer cover 4 and the two detection devices 2L, 2R. The outer cover 4 can be opened and closed like a book, such that the front side of the information input device 1 forms a two-page spread. The detection devices 2L, 2R are assembled onto the outer cover 4.

The information input device 1 is capable of reading information that the user records with an electronic pen 6 on a booklet-shaped recording medium (for example, the notebook 5) that has been placed on the detection devices 2L, 2R. The electronic pen 6 is a writing implement that can record information (text characters, symbols, figures, numerals, and the like) in ink in the notebook 5 and can also input the information it records to the detection devices 2L, 2R. A variable-capacitance capacitor, a coil, and the like (not shown in the drawings) that make up a known resonant circuit are provided in the interior of the electronic pen 6. Utilizing a known electromagnetic induction method, the detection devices 2L, 2R are able to detect the position of the electronic pen 6 when it comes near.

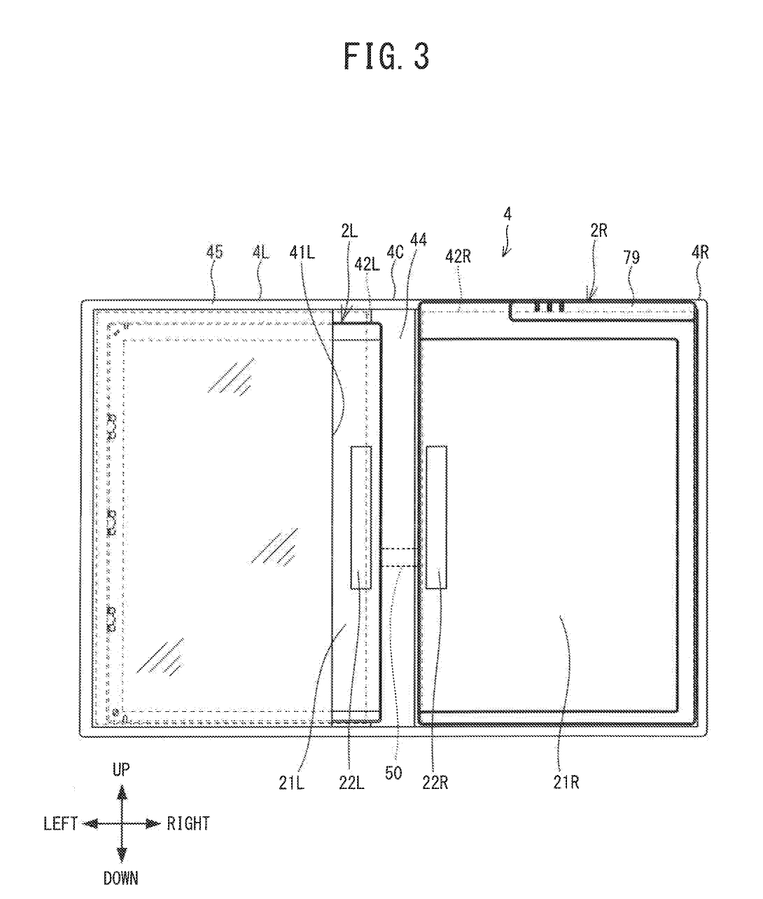

As shown in FIGS. 1 to 3, the notebook 5 is affixed to the front faces of the detection devices 2L, 2R. Recessed positioning portions 21L, 21R are provided on the front faces of the detection devices 2L, 2R, respectively. The positioning portion 21L positions a left cover 51L of the notebook 5 that is affixed to the detection device 2L. The positioning portion 21R positions a right cover 51R of the notebook 5 that is affixed to the detection device 2R.

More specifically, the positioning portion 21L has differences in level on its upper, left, and lower sides, and does not have a difference in level on its right side. The user positions the notebook 5 by butting the upper, left, and lower edges of the left cover 51L up against the corresponding differences in level of the positioning portion 21L. An adhesive portion 22L (refer to FIG. 1) that is slightly adhesive and from which the left cover 51L can be easily separated is provided in a position that is close to the right edge of the recessed area of the positioning portion 21L. The left cover 51L is affixed to the positioning portion 21L by being stuck to the adhesive portion 22L.

The positioning portion 21R has differences in level on its upper, right, and lower sides, and does not have a difference in level on its left side. The user positions the notebook 5 by butting the upper, right, and lower edges of the right cover 51R up against the corresponding differences in level of the positioning portion 21R. An adhesive portion 22R (refer to FIG. 1) that is slightly adhesive and from which the right cover 51R can be easily separated is provided in a position that is close to the left edge of the recessed area of the positioning portion 21R. The right cover 51R is affixed to the positioning portion 21R by being stuck to the adhesive portion 22R.

The outer cover 4 is a rectangular plate-shaped body whose longer axis extends in the left-right direction in a state in which the outer cover 4 is not folded. The outer cover 4 includes a left cover 4L, a right cover 4R, and a folding portion 4C. The left cover 4L holds the detection device 2L. The right cover 4R anchors the detection device 2R. The folding portion 4C links the left cover 4L and the right cover 4R in the center of the left-right direction.

The outer cover 4 is made from a material, such as synthetic leather or nylon (registered trademark), for example, that has a pliability that allows the outer cover 4 to change shape in response to an external force. Sheets 42L, 42R that have insulating properties are incorporated into the interiors of the left cover 4L and the right cover 4R, respectively. The sheets 42L, 42R disposed such that they substantially cover the entire areas of the left cover 4L and the right cover 4R, respectively. The folding portion 4C can be folded toward the front side along an axis AX (refer to FIG. 1). In other words, folding the folding portion 4C of the outer cover 4 makes it possible for the detection device 2L and the detection device 2R to be brought together such that they face one another.

The back face (rear face) of the detection device 2R is affixed to the right cover 4R using double-sided adhesive tape or the like, for example. A battery mounting portion (not shown in the drawings) for powering the detection devices 2L, 2R is provided on the back face of the detection device 2R. A battery cover (not shown in the drawings) is provided on the back face of the outer cover 4 using a hook and loop fastener. By opening and closing the battery cover (not shown in the drawings), the user can replace the battery in the battery mounting portion (not shown in the drawings) without removing the detection device 2R from the outer cover 4.

A holding sheet 41L that holds the detection device 2L is provided on the left cover 4L. The holding sheet 41L may be a transparent, soft vinyl chloride sheet, for example. The upper, left, and lower edges of the holding sheet 41L are woven onto an edge portion 45 of the outer cover 4. The right edge of the holding sheet 41L is open. The detection device 2L is inserted between the left cover 4L and the holding sheet 41L from the right side. The detection device 2L is held by the holding sheet 41L in a state in which the right edge of the detection device 2L protrudes to the right from the right edge of the holding sheet 41L.

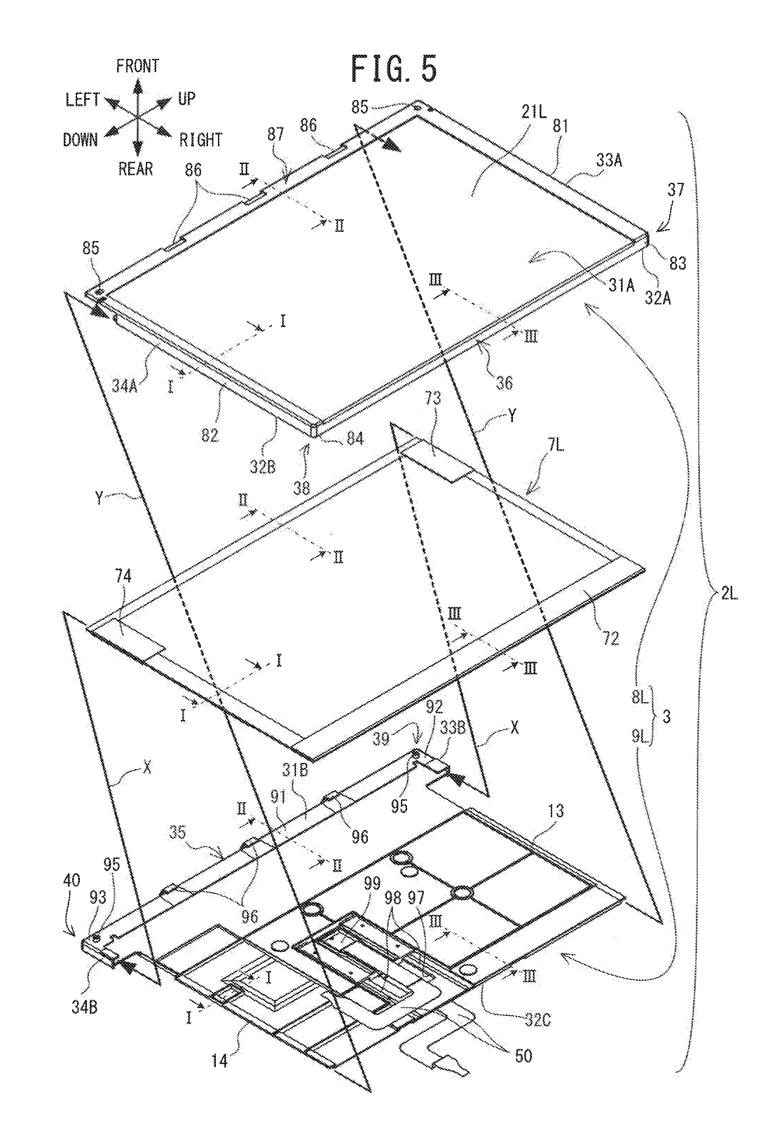

A holder 99 (refer to FIG. 5) that can slide to the left and the right is provided on the rear side of the detection device 2L. The holder 99 is secured to an anchoring portion (not shown in the drawings) that is provided in the outer cover 4. The detection device 2L is thus held by the holding sheet 41L in a state in which it can slide to the left and the right.

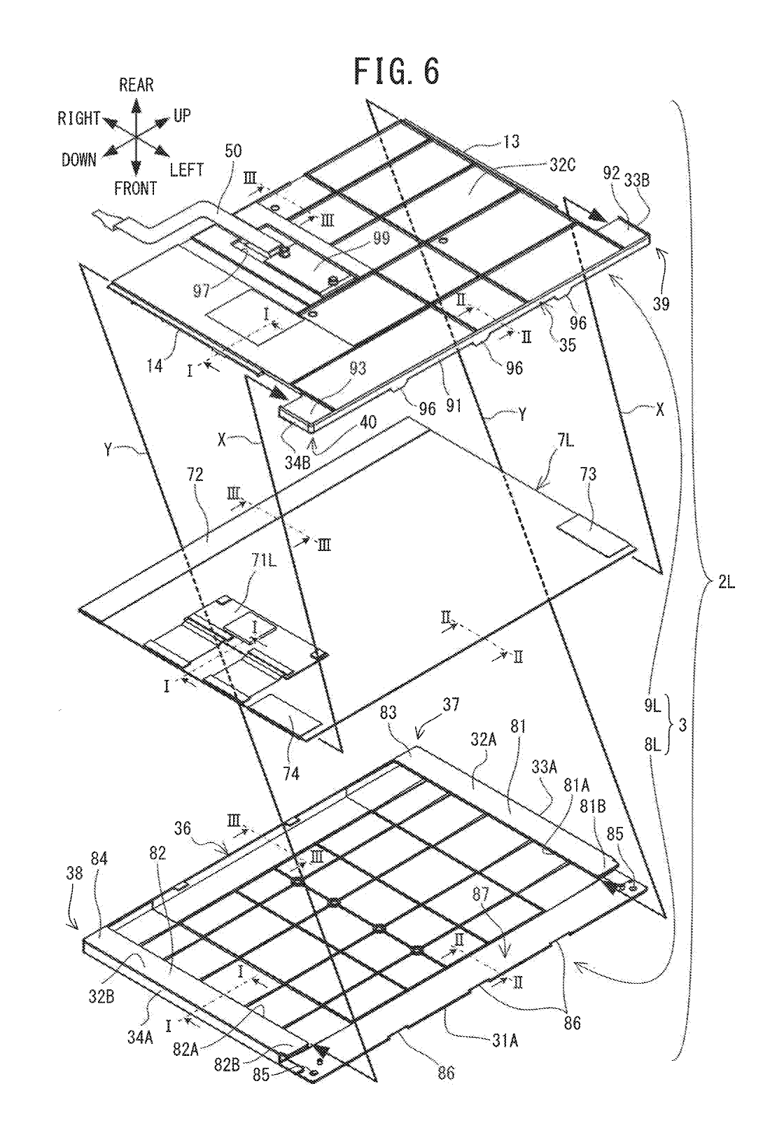

The outer cover 4 is provided with a wide band-shaped body 44 that covers the folding portion 4C. The band-shaped body 44 is provided on the inner side (the front side in FIG. 2) of the folding portion 4C, and it extends tautly between the upper end and the lower end of the folding portion 4C. Both the upper and lower ends of the band-shaped body 44 are woven onto the edge portion 45 of the outer cover 4. The detection devices 2L, 2R are electrically connected through a harness 50 (refer to FIG. 1). The harness 50 is a flexible substrate that electrically connects a control circuit board (not shown in the drawings) and a control circuit board 71L (refer to FIG. 6) that will be described later. The harness 50 passes between the band-shaped body 44 and the inner face of the folding portion 4C, so it is concealed by the band-shaped body 44.

As described previously, the detection devices 2L, 2R are devices that can use a known electromagnetic induction method to detect the position of the electronic pen 6. In a front view, the detection devices 2L, 2R are rectangular, with their longer axes extending in the up-down direction, and they are box-shaped bodies whose thicknesses from front to rear are small. The detection device 2R contains a digitizer circuit board, the control circuit board, and a main circuit board, although these are not shown in the drawings. The digitizer circuit board is a circuit board for detecting the position of the electronic pen 6. The control circuit board is a circuit board for controlling the electric current that flows to the digitizer circuit board. The main circuit board is a circuit board that is electrically connected to the control circuit board and on which is mounted a CPU that controls the information input device 1.

The main circuit board is provided with a power switch, a light-emitting element, a communication portion, and the like, as well as with parts such as various types of switches, connectors, and the like (none of which are shown in the drawings). The main circuit board is contained in a containing portion 79 that is provided in the right-hand part of the upper edge of the detection device 2R. Through the communication portion, the main circuit board can perform wireless and wired communications with external devices (for example, a PC or the like) that are not shown in the drawings.

The digitizer circuit board is a circuit board on which large numbers of long, thin loop coils are arrayed along both an X axis (specifically, the left-right axis) and a Y axis (specifically, the up-down axis). The control circuit board generates a magnetic field by causing an electric current of a specified frequency (a sending current for excitation) to flow through the loop coils one at a time. The control circuit board detects an electric current (a signal current) that is made to flow through the loop coils by an induction field that is generated by the resonant circuit of the electronic pen 6 that is close to the digitizer circuit board. Based on the signal current that the control circuit board detects, the CPU of the main circuit board determines the coordinates of the positions of the electronic pen 6 over the course of time and creates stroke data that indicate the track of the electronic pen 6. The CPU of the main circuit board outputs the stroke data it has created to an external device (a PC or the like) that is connected to the information input device 1.

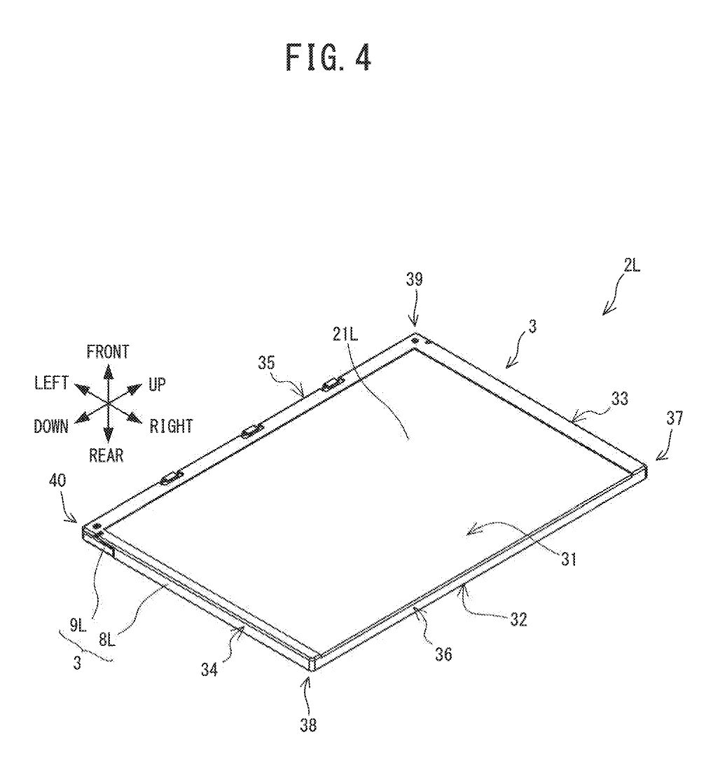

The detection device 2L will be explained with reference to FIGS. 4 to 9. The detection device 2L that is shown in FIG. 4 is a box-shaped body whose thickness dimension extends in the front-rear direction and that has a rectangular plate shape that is longer in the up-down direction than in the left-right direction. As shown in FIGS. 5 and 6, the detection device 2L is provided with a front cover 8L, a rear cover 9L, a digitizer circuit board 7L, the control circuit board 71L (refer to FIG. 6), the harness 50, and the holder 99.

The front cover 8L and the rear cover 9L are combined to form a housing 3 of the detection device 2L. In the present embodiment, the housing 3 is made up of six wall sections that are disposed in three pairs in front-rear direction, the up-down direction, and the left-right direction, respectively. As shown in FIG. 4, the housing 3 is provided with a front wall 31, a rear wall 32, a left side wall 35, a right side wall 36, a top side wall 33, and a bottom side wall 34 that respectively serve as a front face, a rear face, a left side face, a right side face, a top face, and a bottom face.

The front wall 31 and the rear wall 32 are a pair of rectangular plate-shaped walls that are disposed such that they face one another in the front-rear direction. The front wall 31 and the rear wall 32 respectively face opposite faces of the digitizer circuit board 7L (refer to FIGS. 5, 6), which is contained in the interior of the housing 3. The top side wall 33, the bottom side wall 34, the left side wall 35, and the right side wall 36 are side walls that connect the perimeter edges of the front wall 31 and the rear wall 32 around the entire perimeter.

The digitizer circuit board 7L and the control circuit board 71L that are shown in FIGS. 5 and 6 respectively have the same configuration as the digitizer circuit board and the control circuit board (not shown in the drawings) of the detection device 2R, and they can detect the position of the electronic pen 6 using the known electromagnetic induction method. The digitizer circuit board 7L and the control circuit board 71L are provided as an integrated unit. The control circuit board 71L is provided on the lower end of the rear face of the digitizer circuit board 7L, and it is disposed close to the center of the digitizer circuit board 7L in the left-right direction.

An insulating member 72 is provided along the entire length of the right edge of the digitizer circuit board 7L, from top to bottom. The insulating member 72 covers the right side face of the digitizer circuit board 7L, as well as the portions of the front and rear faces of the digitizer circuit board 7L that are close to the right edge. Insulating members 73, 74 of the same sort as the insulating member 72 are provided on the upper left corner and the lower left corner of the digitizer circuit board 7L, respectively. The insulating member 73 covers the top side face and the front and rear faces of the digitizer circuit board 7L in the vicinity of the upper left corner. The insulating member 74 covers the bottom side face and the front and rear faces of the digitizer circuit board 7L in the vicinity of the lower left corner. The insulating members 72 to 74 are tapes or the like with strong insulating properties, for example, and they protect the digitizer circuit board 7L from static electricity.

The front cover 8L is formed with a first front wall 31A as its main component. The first front wall 31A forms a portion of the front wall 31 except for a second front wall 31B that will be described later. The first front wall 31A covers the entire front face of the housing 3. On the front cover 8L, the right side wall 36, a first top side wall 33A, and a first bottom side wall 34A extend toward the rear from the respective edges of the first front wall 31A. The right side wall 36 is formed such that it extends from an upper right corner 37 of the housing 3 to a lower right corner 38 of the housing 3. The top side wall 33 includes the first top side wall 33A. The first top side wall 33A is a wall that extends from the upper edge of the right side wall 36 to the right side of an upper left corner 39 of the housing 3. The bottom side wall 34 includes the first bottom side wall 34A. The first bottom side wall 34A is a wall that extends from the lower edge of the right side wall 36 to the right side of a lower left corner 40 of the housing 3.

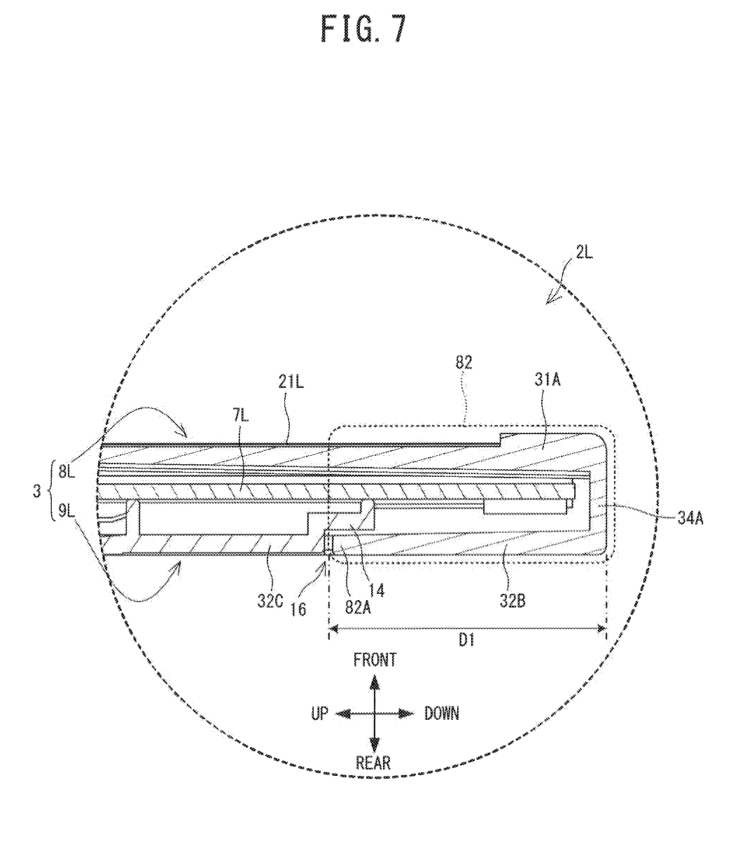

A second rear wall 32B is a wall that extends upward from the rear edge of the first bottom side wall 34A and forms a portion of the rear wall 32. The second rear wall 32B extends upward from the rear edge of the first bottom side wall 34A across the entire length of the first bottom side wall 34A, from left to right. The second rear wall 32B has a rectangular plate shape whose longer axis extends in the left-right direction and that has a specified width from top to bottom. As shown in FIG. 7, a folded edge portion 82 is formed on the lower edge of the front cover 8L. The folded edge portion 82 is the portion where the first front wall 31A, the first bottom side wall 34A, and the second rear wall 32B are connected into a single plate-shaped unit at the lower edge of the first front wall 31A.

As shown in FIGS. 5 and 6, the first top side wall 33A has the same sort of structure as the first bottom side wall 34A. A first rear wall 32A is a wall that extends downward from the rear edge of the first top side wall 33A and forms a portion of the rear wall 32. The first rear wall 32A extends downward from the rear edge of the first top side wall 33A across the entire length of the first top side wall 33A, from left to right. The first rear wall 32A has a rectangular plate shape whose longer axis extends in the left-right direction and that has a specified width from top to bottom. A folded edge portion 81 is formed on the upper edge of the front cover 8L. The folded edge portion 81 is the portion where the first front wall 31A, the first top side wall 33A, and the first rear wall 32A are connected into a single plate-shaped unit at the upper edge of the first front wall 31A.

In other words, on the front cover 8L, the pair of folded edge portions 81, 82 are respectively provided on the upper and lower edges of the first front wall 31A. The pair of folded edge portions 81, 82 are bag-shaped folded portions that are positioned opposite one another in the up-down direction. Note that a projecting portion 81B projects from the left edge of the first rear wall 32A, projecting farther to the left than the edge of the first top side wall 33A. A projecting portion 82B projects from the left edge of the second rear wall 32B, projecting farther to the left than the edge of the first bottom side wall 34A.

The right edge of the first rear wall 32A is connected to the right side wall 36. The right edge of the folded edge portion 81 forms a bag-shaped portion that is enclosed on four sides by the first front wall 31A, the first top side wall 33A, the first rear wall 32A, and the right side wall 36. The bag-shaped portion is called a folded corner portion 83. In the same manner, the right edge of the second rear wall 32B is connected to the right side wall 36. The right edge of the folded edge portion 82 forms a bag-shaped portion that is enclosed on four sides by the first front wall 31A, the first bottom side wall 34A, the second rear wall 32B, and the right side wall 36. The bag-shaped portion is called a folded corner portion 84.

A pair of dowel holes 85 and a plurality of latches 86 are provided on the left edge of the first front wall 31A. A pair of dowels 95 that will be described later can be fitted into the corresponding ones of the pair of dowel holes 85. A plurality of hooks 96 that will be described later can be fitted into the corresponding ones of the plurality of the latches 86.

The rear cover 9L is formed with a third rear wall 32C as its main component. The third rear wall 32C forms a portion of the rear wall 32 except for the first rear wall 32A and the second rear wall 32B. The third rear wall 32C covers almost the entire rear face of the housing 3. An opening 97 is formed close to the center of the third rear wall 32C in the up-down direction. A pair of rails 98 that extend in the left-right direction are provided on the upper and lower edges of the opening 97.

The rear cover 9L is provided with the box-shaped holder 99, the rear face and the right face of which are open. The holder 99 is disposed in the opening 97 in a state in which the holder 99 is fitted onto the pair of rails 98. The holder 99 is supported such that it is able to slide to the left and the right in relation to the rear cover 9L. The holder 99 inhibits the deformation of the aforementioned harness 50 by a load that bears on the harness 50 when the detection device 2L slides.

On the rear cover 9L, the left side wall 35, a second top side wall 33B, and a second bottom side wall 34B extend toward the front from the respective edges of the third rear wall 32C. The left side wall 35 is formed such that it extends from the upper left corner 39 to the lower left corner 40 of the housing 3. The top side wall 33 includes the second top side wall 33B. The second top side wall 33B is a wall that extends in the left-right direction along the upper left corner 39. The bottom side wall 34 includes the second bottom side wall 34B. The second bottom side wall 34B is a wall that extends in the left-right direction along the lower left corner 40.

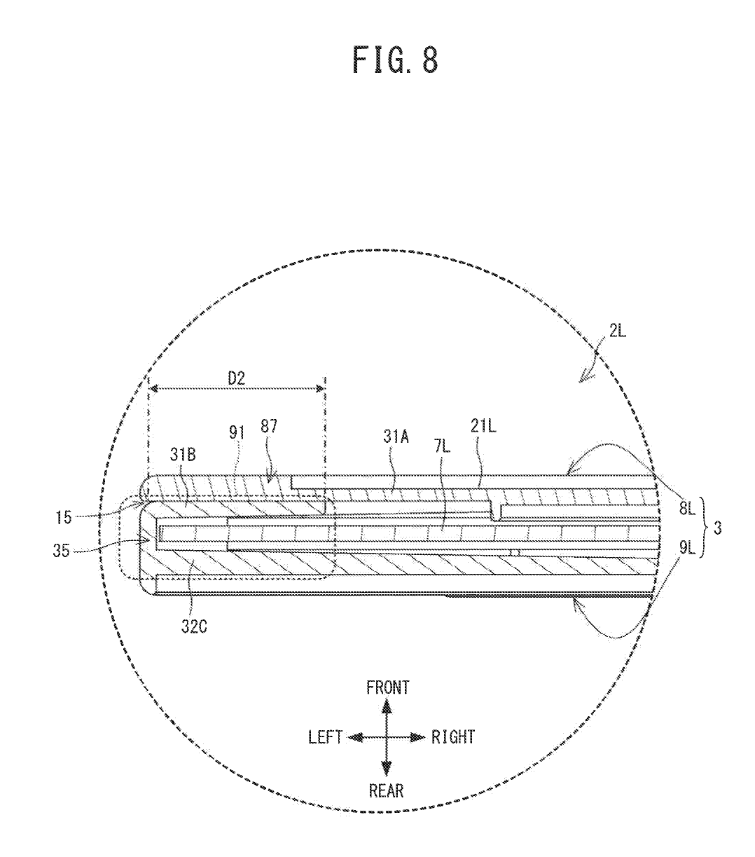

The second front wall 31B is a wall that extends to the right from the front edge of the left side wall 35. The second front wall 31B is a wall within the front wall 31 that is disposed to the rear of the left edge of the first front wall 31A. The second front wall 31B extends to the right from the front edge of the left side wall 35 along the entire length of the left side wall 35, from top to bottom. The second front wall 31B has a rectangular plate shape whose longer axis extends in the up-down direction and that has a specified width from left to right. As shown in FIG. 8, a folded edge portion 91 is formed on the left edge of the rear cover 9L. The folded edge portion 91 is the portion where the third rear wall 32C, the left side wall 35, and the second front wall 31B are connected into a single plate-shaped unit at the left edge of the third rear wall 32C.

As shown in FIGS. 5 and 6, the upper and lower ends of the second front wall 31B are connected to the second top side wall 33B and the second bottom side wall 34B, respectively. The upper edge of the folded edge portion 91 forms a bag-shaped portion that is enclosed on four sides by the third rear wall 32C, the left side wall 35, the second front wall 31B, and the second top side wall 33B. The bag-shaped portion is called a folded corner portion 92. In the same manner, the lower edge of the folded edge portion 91 forms a bag-shaped portion that is enclosed on four sides by the third rear wall 32C, the left side wall 35, the second front wall 31B, and the second bottom side wall 34B. The bag-shaped portion is called a folded corner portion 93.

As shown in FIG. 8, the first front wall 31A of the front cover 8L covers the second front wall 31B of the rear cover 9L from the front side. The portion of the first front wall 31A that covers the second front wall 31B is a covering portion 87. When the housing 3 is constructed by combining the front cover 8L and the rear cover 9L, an area (a contact portion 15) is formed in which the covering portion 87 and the second front wall 31B are in contact. The providing of the covering portion 87 means that the contact portion 15 is exposed on the left face of the housing 3 and not on the front face of the housing 3.

As shown in FIGS. 5 and 6, the rear cover 9L is provided with step portions 13, 14. The step portions 13, 14 are respectively provided on the upper and lower edges of the third rear wall 32C. The rear faces of the step portions 13, 14 are positioned to the front of the rear face of the third rear wall 32C. Therefore, the step portions 13, 14 form differences in level on the rear face side of the third rear wall 32C. The step portion 13 comes into contact with the inner side of the housing 3 at the edge of the first rear wall 32A of the front cover 8L (that is, at an edge portion 81A of the folded edge portion 81). The step portion 14 comes into contact with the inner side of the housing 3 at the edge of the second rear wall 32B of the front cover 8L (that is, at an edge portion 82A of the folded edge portion 82) (refer to FIG. 7).

In the present embodiment, the step portion 13 comes into contact with the edge portion 81A over a portion of the length of the folded edge portion 81 in the left-right direction. Instead of this, the step portion 13 may also come into contact with the edge portion 81A over the entire length of the folded edge portion 81 in the left-right direction. In other words, it is a good idea for the step portion 13 to come into contact with the edge portion 81A in order to prevent the rear cover 9L from separating from the folded edge portion 81 after being combined with the front cover 8L. In the same manner, it is a good idea for the step portion 14 to come into contact with the edge portion 82A over all or a part of the length of the folded edge portion 82 in the left-right direction. Note that at the folded edge portions 81, 82, an area (a contact portion 16) where the faces of the front cover 8L and the rear cover 9L come into contact is exposed on the rear face of the housing 3.

The pair of dowels 95 and the plurality of hooks 96 are provided on the left edge of the second front wall 31B. The pair of dowels 95 can be fitted into the corresponding ones of the aforementioned pair of the dowel holes 85. The plurality of the hooks 96 can be fitted into the corresponding ones of the aforementioned plurality of the latches 86.

Following a procedure that will hereinafter be described, an operator assembles the detection device 2L that is described above as shown in FIGS. 5 and 6. First, the operator places the holder 99 in the opening 97 of the rear cover 9L and fits it to the rails 98. The operator passes the harness 50 through the opening 97 and affixes a part of the harness 50 to the inside of the holder 99 using double-sided tape or the like. The operator inserts a terminal portion of the harness 50 into a connector portion of the control circuit board 71L. The operator affixes the harness 50 to the rear face of the digitizer circuit board 7L using double-sided tape or the like.

The operator inserts the upper left corner and the lower left corner of the digitizer circuit board 7L into the folded corner portions 92, 93 of the rear cover 9L, respectively, as indicated by arrows X in FIGS. 5 and 6. The left edge of the digitizer circuit board 7L is thus positioned inside the folded edge portion 91 of the rear cover 9L (refer to FIG. 8). A portion of each one of the insulating members 73, 74 that are provided on the digitizer circuit board 7L is positioned inside the corresponding one of the folded corner portions 92, 93. The insulating members 73, 74 extend to the right side from the interiors of the respective folded corner portions 92, 93. The insulating member 72 is positioned along the right edge of the rear cover 9L.

After installing the digitizer circuit board 7L, the operator positions the upper right corner and the lower right corner of the rear cover 9L on the left edges of the folded edge portions 81, 82 of the front cover 8L, respectively, as indicated by arrows Y in FIGS. 5 and 6. The operator brings the step portions 13, 14 of the rear cover 9L into contact with the edge portions 81A, 82A of the folded edge portions 81, 82 of the front cover 8L, respectively. Note that the position of the rear cover 9L in relation to the front cover 8L in the state before the front cover 8L and the rear cover 9L are combined will be called the unassembled position.

Maintaining the state in which the step portions 13, 14 are in contact with the edge portions 81A, 82A, the operator slides the rear cover 9L toward the right in relation to the front cover 8L. The third rear wall 32C of the rear cover 9L is thus moved to a position where it faces the first front wall 31A of the front cover 8L. The covering portion 87 of the front cover 8L arrives at a position where it covers the second front wall 31B of the rear cover 9L. The projecting portions 81B, 82B of the front cover 8L are inserted into the folded corner portions 92, 93 of the rear cover 9L.

Note that the position of the rear cover 9L in relation to the front cover 8L in the state after the front cover 8L and the rear cover 9L have been combined will be called the assembled position. With the step portions 13, 14 in the state of being in contact with the edge portions 81A, 82A, the operator slides the rear cover 9L between the unassembled position and the assembled position.

When the rear cover 9L is moved from the unassembled position to the assembled position, the pair of dowels 95 of the rear cover 9L are fitted into the pair of dowel holes 85 of the front cover 8L, and the plurality of the hooks 96 of the rear cover 9L are fitted into the plurality of the latches 86 of the front cover 8L. The rear cover 9L is thus positioned in relation to the front cover 8L and fixed in place. The upper edge of the digitizer circuit board 7L is positioned inside the folded edge portion 81, and the lower edge of the digitizer circuit board 7L is positioned inside the folded edge portion 82. The upper right corner of the digitizer circuit board 7L is positioned inside the folded corner portion 83, and the lower right corner of the digitizer circuit board 7L is positioned inside the folded corner portion 84. The detection device 2L that is shown in FIG. 4 is thus assembled.

As described previously, in the detection device 2L, the covering portion 87 covers the second front wall 31B. At least a distance D2 that is equal to the length of the second front wall 31B that is in the folded edge portion 91 can thus be ensured between the outside of the housing 3 and the digitizer circuit board 7L that is contained within the housing 3, as shown in FIG. 8. In other words, the distance D2 can be ensured in the contact portion 15 of the housing 3. Static electricity that is generated outside of the housing 3, for example, is thus inhibited from entering the housing 3 through the contact portion 15. Static electricity can be inhibited from affecting the digitizer circuit board 7L.

Because the folded edge portion 91 has a shape in which the left edge of the rear cover 9L is folded, the rigidity of the edge of the housing 3 can be improved. The edge of the digitizer circuit board 7L that is positioned inside the folded edge portion 91 can be protected. In particular, the folded corner portions 92, 93 can protect the corners of the digitizer circuit board 7L from four sides. Including the folded corner portions 92, 93 in the folded edge portion 91 makes it possible for the folded edge portion 91 to be supported by the second top side wall 33B and the second bottom side wall 34B. Therefore, the rigidity of the edge of the housing 3 can be further improved.

The detection device 2L is used by holding the left cover 4L, so the left cover 4L is positioned such that it faces the rear face of the housing 3. Furthermore, the sheet 42L, which has insulating properties, is incorporated into the left cover 4L. It is therefore difficult for static electricity that is generated outside of the housing 3 to pass through the sheet 42L of the outer cover 4. Accordingly, the static electricity tends to follow a path by which it travels from the side of the housing 3 (specifically, the bottom side of the housing 3), between the outer cover 4 and the second rear wall 32B of the folded edge portion 82, and enters the housing 3 through the contact portion 16.

The detection device 2L includes the folded edge portion 82. At least a distance D1 that is equal to the length of the second rear wall 32B that is in the folded edge portion 82 can thus be ensured between the outside of the side of the housing 3 (specifically, the bottom side of the housing 3) and the contact portion 16, as shown in FIG. 7. Because the distance D1 is ensured, static electricity is inhibited from entering the housing 3 through the contact portion 16. Static electricity can be inhibited from affecting the digitizer circuit board 7L.

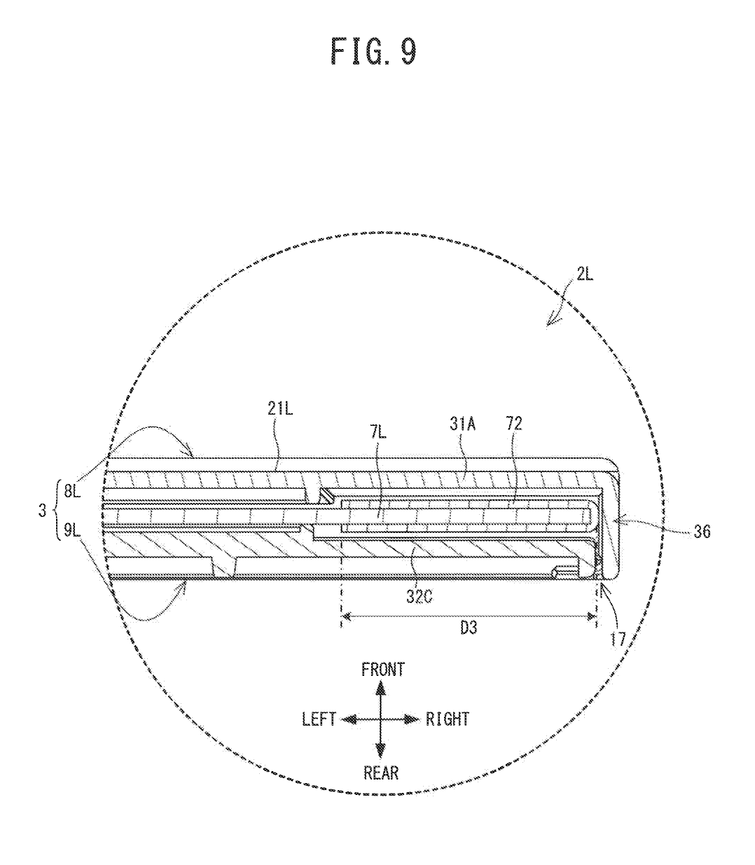

As shown in FIG. 9, a folded edge portion is not formed on the right edge of the housing 3. However, the insulating member 72 is provided on the digitizer circuit board 7L, so static electricity can be inhibited from entering from the right edge of the housing 3.

A contact portion 17 between the front cover 8L and the rear cover 9L is formed on the rear face of the housing 3. The contact portion 17 is where the rear edge of the right side wall 36 of the front cover 8L comes into contact with the third rear wall 32C of the rear cover 9L. In the state in which the rear face of the housing 3 is facing the left cover 4L, as described above, the contact portion 17 is close to the outside of the right side of the housing 3. The providing of the insulating member 72 on the right edge of the digitizer circuit board 7L means that at least a distance D3 that is equal to the length of the insulating member 72 is ensured between the contact portion 16 and the digitizer circuit board 7L. Because the distance D3 is ensured, static electricity that has entered the contact portion 17 can be inhibited from reaching the digitizer circuit board 7L.

In the same manner as described above, the insulating members 73, 74 are provided on the upper right corner and the lower right corner of the digitizer circuit board 7L. At least a distance that is equal to the lengths of the insulating members 73, 74 can thus be ensured on the path by which static electricity travels.

The information input device 1 of the present disclosure is provided with the digitizer circuit board 7L and the box-shaped housing 3. The housing 3 is constructed by combining at least two members (the front cover 8L, the rear cover 9L). The housing 3 includes a pair of plate walls (the front wall 31, the rear wall 32), as well as side walls (the front wall 31, the rear wall 32, the left side wall 35, the right side wall 36, the top side wall 33, and the bottom side wall 34). The rear cover 9L includes the third rear wall 32C as its main component, as well as the folded edge portion 91. The third rear wall 32C is at least a portion of the rear wall 32. The folded edge portion 91 is where the third rear wall 32C, the left side wall 35, and the second front wall 31B are connected into a single unit in folded form at the edge of the third rear wall 32C. The second front wall 31B is a wall that is positioned opposite the third rear wall 32C such that the digitizer circuit board 7L that is contained inside the housing 3 is sandwiched between the second front wall 31B and the third rear wall 32C. The folded edge portion 91 accommodates an edge of the digitizer circuit board 7L that is contained inside the housing 3.

The length of the path that static electricity that is generated outside of the housing 3 must follow in order to reach the digitizer circuit board 7L is thus ensured, so the effects of static electricity on the digitizer circuit board 7L can be inhibited. Because the digitizer circuit board 7L is disposed on the edge of the housing 3, it is possible to make the housing 3 compact and slim. The forming of the folded edge portion 91 in a folded shape makes it possible to improve the rigidity of the edge of the housing 3. In the same manner, because the front cover 8L includes the pair of folded edge portions 81, 82, the housing 3 can be made compact and slim.

The folded edge portion 91 includes the folded corner portions 92, 93. That makes it possible to position the digitizer circuit board 7L at the corners of the housing 3, so the housing 3 can be made compact and slim. Because the folded corner portions 92, 93 are bag-shaped, the rigidity of the corners of the housing 3 can be improved. In the same manner, because the folded edge portions 81, 82 include the folded corner portions 83, 84, respectively, the housing 3 can be made compact and slim.

The folded edge portion 91 extends along the side that forms the edge of the rear cover 9L from the positions where the folded corner portions 92, 93 are formed, covering at least half of the length of the side. It is thus possible to ensure that the folded edge portion 91 is sufficiently rigid, even in a case where it is quite long in a single direction. Because the digitizer circuit board 7L can be positioned from the edge to the corners of the housing 3, the housing 3 can be made compact and slim. In the same manner, it is possible to ensure that the folded edge portions 81, 82 are sufficiently rigid, even in a case where they are quite long in a single direction.

The front cover 8L includes the first front wall 31A as its main component, as well as the covering portion 87. The first front wall 31A is at least a portion of the front wall 31. The covering portion 87 covers the second front wall 31B from the outer side of the housing 3. Static electricity thus enters between the covering portion 87 and the second front wall 31B. Because the length of the path that static electricity travels to reach the digitizer circuit board 7L from the outside of the housing 3 can be made longer, the effects of static electricity on the digitizer circuit board 7L can be inhibited.

The pair of folded edge portions 81, 82 are provided on two edges that face one another on opposite sides of the first front wall 31A. The folded edge portion 81 is where the first front wall 31A, the first top side wall 33A, and the first rear wall 32A are connected into a single unit in folded form. The folded edge portion 82 is where the first front wall 31A, the first bottom side wall 34A, and the second rear wall 32B are connected into a single unit in folded form. The first rear wall 32A and the second rear wall 32B are walls that are positioned opposite the first front wall 31A such that the digitizer circuit board 7L that is contained inside the housing 3 is sandwiched between the first front wall 31A on one side and the first rear wall 32A and the second rear wall 32B on the other side. The rear cover 9L includes the pair of step portions 13, 14. At two edges that face one another on opposite sides of the third rear wall 32C, the pair of step portions 13, 14 are configured to come into contact with the corresponding edges of the pair of folded edge portions 81, 82 from the inner side of the housing 3. The rear cover 9L is configured to move between a position where it is joined to the front cover 8L and a position where it is separated from the front cover 8L, in a state in which the pair of step portions 13, 14 are in contact with the pair of folded edge portions 81, 82.

The operator is thus able to combine the front cover 8L and the rear cover 9L by using the folded edge portions 81, 82. A special-purpose member for assembling the housing 3 does not need to be provided separately from the front cover 8L and the rear cover 9L, so the housing 3 can be made compact and slim.

The insulating member 72 is provided between the digitizer circuit board 7L that is contained in the housing 3 and the contact portion 17 that is formed in the housing 3. The path by which static electricity would travel to the digitizer circuit board 7L is thus blocked by the insulating member 72, even if static electricity enters the housing 3 through the contact portion 17. The effects of static electricity on the digitizer circuit board 7L can be inhibited.

The contact portions of the front cover 8L and the rear cover 9L are formed in positions that are on sides other than a detection surface side (the front side) of the digitizer circuit board 7L. It is thus difficult for the electronic pen 6 to get caught on the contact portions, so the positions of the electronic pen 6 can be detected smoothly. Taking into consideration the design, the layout, and the like of the information input device 1, it is difficult to implement measures against static electricity on the detection surface side. The forming of the contact portions in positions that are not on the detection surface makes it possible to implement measures against static electricity easily.

The outer cover 4, which incorporates the insulating sheet 42L, is positioned elsewhere than on the detection surface side of the digitizer circuit board 7L. The length of the path that static electricity travels to enter the housing 3 from elsewhere than on the detection surface side can thus be made longer, so the effects of static electricity on the digitizer circuit board 7L can be inhibited.

The present disclosure is not limited to the embodiment that has been explained above, and various types of modifications can be made. The detection devices 2L, 2R may also use a technique other than the known electromagnetic induction method to detect the position of an object of detection (in the present embodiment, the electronic pen 6) that is close to or in contact with the detection devices 2L, 2R. For example, the detection devices 2L, 2R may also use another method, such as a resistive film method (also called a pressure-sensitive method), a static electric capacitance method, or the like, to detect the position of the object of detection that is close to or in contact with the detection devices 2L, 2R.

The size, the format, the material, and the like of the notebook 5 are also not limited to the embodiment that has been described above. The method by which the notebook 5 is attached to the detection devices 2L, 2R is not limited to the embodiment that has been described above. The housing 3 is not limited to being configured by the combining of the two members of the front cover 8L and the rear cover 9L, and it may also be configured by combining not less than three members.

The apparatus and methods described above with reference to the various embodiments are merely examples. It goes without saying that they are not confined to the depicted embodiments. While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. An information input device, comprising:
a digitizer circuit board that is configured to detect a position of an object of detection that is one of close to and in contact with the digitizer circuit board; and
a box-shaped housing that is configured to contain the digitizer circuit board, the housing being constructed by combining at least two members and including a pair of plate walls and a side wall, the pair of plate walls being respectively positioned opposite two faces of the digitizer circuit board that is contained inside the housing, the side wall being connected to edges of the pair of plate walls, the at least two members including a first member, the first member having a first main wall as a main component of the first member and including a first folded edge portion, the first main wall being at least a portion of a first plate wall that is one of the pair of plate walls, the first folded edge portion being a portion where the first main wall, the side wall, and a first opposing wall are connected into a single unit in folded form at at least one edge of the first main wall, the first opposing wall being a wall that is positioned opposite the first main wall such that the digitizer circuit board that is contained inside the housing is sandwiched between the first opposing wall and the first main wall, and the first folded edge portion accommodating an edge of the digitizer circuit board that is contained inside the housing.

2. The information input device according to claim 1, wherein
the first folded edge portion includes a folded corner portion, the folded corner portion being a portion where the first main wall, the side wall, and the first opposing wall are connected into a single unit in folded form at at least one corner of the first main wall, and the folded corner portion accommodating a corner of the digitizer circuit board that is contained inside the housing.

3. The information input device according to claim 2, wherein
the folded edge portion extends along a side that forms an edge of the first member from a position where the folded corner portion is formed, covering at least half of the length of the side.

4. The information input device according to claim 1, wherein
the at least two members includes a second member, the second member having a second main wall as a main component of the second member and including a covering portion, the second main wall being at least a portion of a second plate wall that is the other of the pair of plate walls and is different from the first plate wall, and the covering portion covering the first opposing wall from an outer side of the housing.

5. The information input device according to claim 4, wherein
the second member includes a pair of second folded edge portions, the pair of second folded edge portions being provided on two edges that face one another on opposite sides of the second main wall, each one of the pair of second folded edge portions being a portion where the second main wall, the side wall, and a second opposing wall are connected into a single unit in folded form, and the second opposing wall being a wall that is positioned opposite the second main wall such that the digitizer circuit board that is contained inside the housing is sandwiched between the second opposing wall and the second main wall,
the first member includes a pair of contact portions, the pair of contact portions that are configured to come into contact with the inner side of the housing at corresponding edges of the pair of second folded edge portions on two edges that face one another on opposite sides of the first main wall, and
the first member is configured to move between a position where the first member is joined to the second member and a position where the first member is separated from the second member, in a state in which the pair of contact portions are in contact with the pair of second folded edge portions.

6. The information input device according to claim 4, further comprising:
an insulating portion that is provided between the digitizer circuit board that is contained inside the housing and a contact portion that is formed in the housing, the contact portion being a portion where the first member and the second member, from which the housing is constructed, are in contact with one another.

7. The information input device according to claim 6, wherein
the contact portion is formed in a position that is different from the position of the one of the pair of plate walls that is disposed on a detection surface side of the digitizer circuit board.

8. The information input device according to claim 1, further comprising:
a holding member that is configured to hold the housing and that faces the one of the pair of plate walls that is disposed on a side of the digitizer circuit board that is not a detection surface side, the holding member incorporating an insulating sheet.
